(19) United States
(12) Patent Application Publication
(10) Pub. No.: US 2008/0112780 A1
(43) Pub. Date: May 15, 2008

(54) VACUUM PROCESSING APPARATUS

(76) Inventors: KATSUJI MATANO, Kudamatsu-shi (JP); Ryoji Hamasaki, Hikari-shi (JP); Masamichi Sakaguchi, Kudamatsu-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/682,992

(22) Filed: Mar. 7, 2007

(30) Foreign Application Priority Data
Nov. 10, 2006 (JP) 2006-305139

(51) Int. Cl. B65G 49/07

(52) U.S. Cl. 414/217.1

(57) ABSTRACT

The invention provides a vacuum processing apparatus comprising: a plurality of vacuum vessels, each having a processing chamber capable of processing a subject substrate sample placed therein under reduced pressure; a cassette stage for mounting a cassette capable of containing a plurality of the samples; at least one transfer apparatus for transferring the sample from the cassette to the processing chamber in one of the vacuum vessels along a predetermined path and returning the sample processed in the processing chamber to the cassette; and an aligner placed on the path between the cassette stage and the plurality of vacuum vessels for aligning the sample to a predetermined position. The aligner aligns the sample to different positions depending on processings applied to the sample.

The present application is based on and claims priority of Japanese patent application No. 2006-305139 filed on Nov. 10, 2006, the entire contents of which are hereby incorporated by reference.

### BACKGROUND OF THE INVENTION

1. Field of the Invention

This invention relates to transferring a semiconductor substrate (hereinafter referred to as “wafer”) between processing chambers of a semiconductor processing system, and more particularly to an apparatus and method for controlling the incision (hereinafter referred to as “notch”) position of a wafer.

2. Description of the Related Art

In a typical vacuum processing apparatus such as a dry etching system, CVD system, or sputtering system, a predetermined number of one or more substrates are treated as a unit (commonly referred to as a lot) and stored in a substrate container, which is then introduced into the system. The processed substrates are also stored in the substrate container and retrieved by the same unit. Thus the production efficiency is enhanced.

Such a vacuum processing apparatus is used to process a semiconductor wafer for manufacturing semiconductor devices such as highly integrated circuits. Such semiconductor devices are configured with an increasingly small length and narrow width for enhancing the operating speed. Semiconductor processing systems are required to have higher processing accuracy for producing such circuits. In particular, etching systems for etching a surface film layer to form interconnects and insulating layers of a circuit are required to accurately form the critical dimensions, which are the minimum widths of the device, thereby increasing the device manufacturing yield.

In a vacuum processing apparatus as described above, particularly in a dry etching system, a sample is placed in a processing chamber in a vacuum processing vessel, and a plasma generated in this processing chamber is used to process the surface of the semiconductor wafer. On the surface of the semiconductor wafer to be etched, a material layer to be processed is placed on the surface of the silicon substrate, and a patterned mask of photoresist or the like is placed on the material layer. In the etching process, the surface of the material layer not covered with the mask is subjected to physical and chemical reactions with the plasma, and the masked portion is left unetched. Thus grooves and holes serving as interconnects and insulating structures are formed.

In this circuit structure where the mask pattern is formed in the underlying material layer to be processed, the lithography process is the key preprocess in wafer processing.

Vacuum processing generally involves a certain directionality with respect to the wafer center or notch. Photolithography recipes are fine-tuned for compensating for this directionality. The orientation of the wafer is crucial to wafer processing. Failure to control the wafer orientation eventually deteriorates processing characteristics. In vacuum processing, it is known that dispersion in processing characteristics is attributed to the difference of relative positions between the exhaust direction (gas flow) or the input direction of source high-frequency waves and the wafer orientation.

The circuit structure of the mask is formed with reference to the notch of the wafer. Hence, also in the subsequent etching processing, an aligner in the atmosphere transfer apparatus is used for accurate notch alignment of all the wafers, and then etching is conducted in each processing chamber. An example vacuum processing apparatus with this capability is disclosed in JP 10-089904A.

However, the conventional technique described above has the following problem in the result of etching even if the notch alignment for wafers is accurately performed:

(1) The relative position of the notch of a wafer depends on the shape or arrangement of each processing vessel. Hence, unfortunately, processing characteristics within a wafer differ between the processing chambers. That is, wafer processing is not sufficiently considered in terms of accuracy and stability to enhance the processing efficiency and yield.

### SUMMARY OF THE INVENTION

An object of the invention is to provide a vacuum processing apparatus by which the within-wafer nonuniformity can be improved in wafer processing based on a plurality of processing chambers to enhance the processing efficiency and yield.

The above object is achieved by a vacuum processing apparatus comprising: a plurality of vacuum vessels, each having a processing chamber capable of processing a subject substrate sample placed therein under reduced pressure; a cassette stage for mounting a cassette capable of containing a plurality of the samples; at least one transfer apparatus for transferring the sample from the cassette to the processing chamber in one of the vacuum vessels along a predetermined path and returning the sample processed in the processing chamber to the cassette; and an aligner placed on the path between the cassette stage and the plurality of vacuum vessels for aligning the sample to a predetermined position, wherein the aligner aligns the sample to different positions depending on processings applied to the sample.

Furthermore, the above object is achieved by a vacuum processing apparatus comprising: a plurality of vacuum vessels, each having a processing chamber capable of processing a subject substrate sample placed therein under reduced pressure; a cassette stage for mounting a cassette capable of containing a plurality of the samples; at least one transfer apparatus for transferring the sample from the cassette to the processing chamber in one of the vacuum vessels along a predetermined path and returning the sample processed in the processing chamber to the cassette; and an aligner placed on the path between the cassette stage and the plurality of vacuum vessels for aligning the sample to a predetermined position, wherein the aligner aligns the sample to different positions depending on the processing chambers applying processings to the sample.

In an aspect of the invention, the aligner aligns the sample to different directions depending on characteristics of the processings applied to the sample. In another aspect of the invention, the sample is shaped like a generally circular plate, and the aligner holds the sample at its center and at a predetermined site having a predetermined shape located on the periphery of the sample around the center so that the transfer apparatus can retrieve the sample from the aligner.

Furthermore, the above object is achieved by a vacuum processing apparatus comprising: a transfer vessel having a generally polygonal planar shape in which a subject sample shaped like a generally circular plate is transferred under reduced pressure; a plurality of processing apparatuses coupled to adjacent sidewalls of the polygon of the transfer vessel, each of the processing apparatuses having a processing chamber capable dof processing the sample transferred therein under reduced pressure; a sample stage placed in the processing chamber in the processing apparatus for mounting the sample on its upper surface; a cassette stage for mounting a cassette capable of containing a plurality of the samples; and at least one transfer apparatus for transferring the sample from the cassette to the processing chamber in one of the processing apparatuses along a predetermined path and returning the sample processed in the processing chamber to the cassette, wherein the plurality of adjacent processing apparatuses are arranged symmetrically with respect to a vertex of the polygon, the upper surface of the sample stage for mounting the sample has a specific feature which is formed in conformity with a specific shape provided at a predetermined site on the periphery of the sample and on which the predetermined site is mounted, and the specific feature is equally arranged with respect to a predetermined direction in each of the processing chambers.

In an aspect of the invention, an incision is provided on the outer periphery of the surface for mounting the generally circular sample, the incision being formed in conformity with the shape of an incision provided on the periphery of the sample. In another aspect of the invention, the vacuum processing apparatus further comprises an aligner placed on the path between the cassette stage and the plurality of processing apparatuses for aligning the sample to a predetermined position, wherein the aligner aligns the predetermined site on the periphery of the sample with the specific feature. In still another aspect of the invention, in each of the processing chambers, the specific feature is equally arranged with respect to the direction of an exhaust opening located below the processing chamber.

According to the invention, it is advantageously possible to provide a vacuum processing apparatus and a vacuum processing method for processing products with high accuracy, that is, realizing high production efficiency and high product yield.

### BRIEF DESCRIPTION OF THE DRAWINGS

FIG. 1 is a top view showing the overall configuration of a vacuum processing apparatus according to a first embodiment of the invention.

FIG. 2 is a schematic enlarged view of the configuration of an atmosphere side block section of the vacuum processing apparatus shown in FIG. 1.

FIG. 3 is a plan view showing the processing flow of wafer transfer in the vacuum processing apparatus shown in FIG. 1.

FIG. 4 is a flow chart showing the flow of operations in the vacuum processing apparatus shown in FIG. 1.

FIGS. 5 and 6 show a second embodiment of the invention with reference to an example case 1 having processing chambers different in hardware (symmetrical arrangement).

FIG. 7 shows a third embodiment of the invention with reference to example cases 2 to 4 having the same apparatus and the same processing chamber hardware as in FIG. 1 (asymmetrical arrangement).

FIG. 8 shows a fourth embodiment of the invention with reference to an example case 5 having different apparatus types.

FIG. 9 is a flow chart showing the flow of operations in the return mode shown in FIG. 4.

### DETAILED DESCRIPTION OF THE PREFERRED EMBODIMENTS

As described above, the invention relates to a vacuum processing apparatus or a vacuum processing method. At predetermined positions therein, the vacuum processing apparatus comprises a vacuum transfer vessel, an atmospheric transfer vessel, a plurality of cassettes, and an aligner for detecting the notch position of a sample at a plurality of arbitrary positions. A plurality of processing vessels are attached to the vacuum transfer vessel, each processing vessel having a processing chamber for processing a sample therein. Before the sample is processed in the processing chamber, the sample is measured at any of the plurality of arbitrary positions in the aligner. Embodiments of the invention will now be described in detail with reference to the drawings.

### First Embodiment

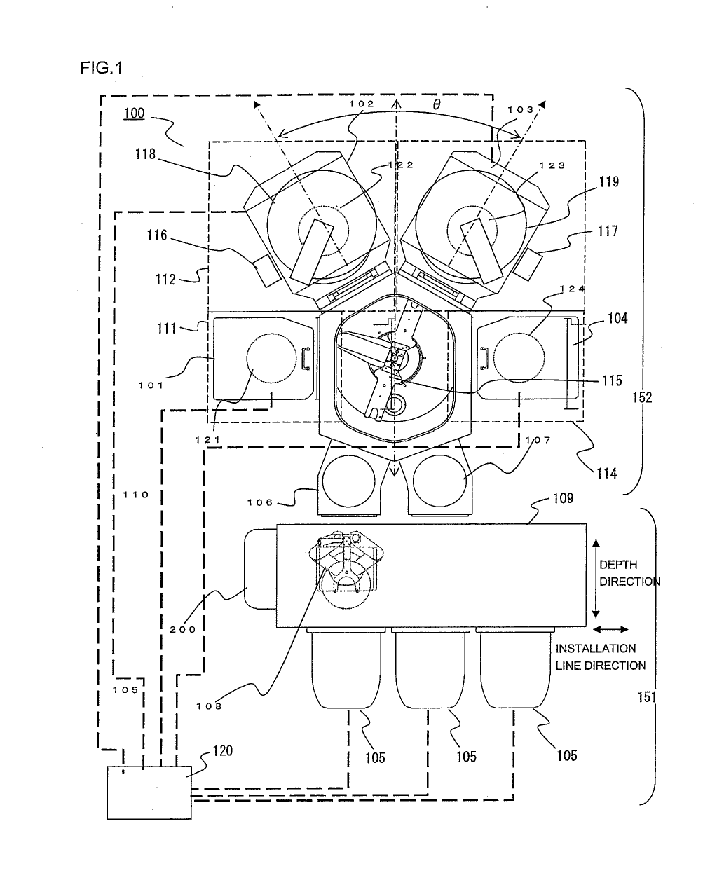

A first embodiment of the invention is described with reference to FIGS. 1 to 4. FIG. 1 is a top view showing the overall configuration of a vacuum processing apparatus according to the embodiment of the invention. In this figure, the vacuum processing apparatus 100 of this embodiment is divided into two major blocks in the front-to-back direction. The front side section of the vacuum processing apparatus 100, shown on the downside in FIG. 1, is an atmosphere side block 151 where a wafer supplied to the apparatus is transferred to a pressure-reducible chamber under atmospheric pressure and supplied to a processing chamber. On the backside of the vacuum processing apparatus 100, shown on the upside of the atmosphere side block 151 in FIG. 1, is a vacuum side block 152 for processing a subject semiconductor wafer or other substrate sample under vacuum.

The atmosphere side block 151 includes a housing 109 equipped therein with an atmospheric transfer robot 108. The atmosphere side block 151 further includes a plurality of cassette stages 105 on the front side of the housing 109. A wafer cassette containing wafers to be processed or to be cleaned or a dummy cassette storing dummy wafers used for cleaning is mounted on the cassette stage 105, which is connected to the housing 109. A plurality of load/unload vessels constituting the front end of the vacuum side block 152 are connected to the backside of the housing 109.

The atmospheric transfer robot 108 transfers a wafer in the cassette between the cassette mounted on the cassette stage 105 and the load/unload vessel. The atmosphere side block 151 further includes an aligner 200 on the left sidewall of the housing 109. The aligner 200 performs aligning operation in which a generally circular wafer transferred from the cassette is aligned at a predetermined position.

The vacuum side block 152 includes processing units 101, 102, 103, 104, and a vacuum transfer unit. In the processing unit, a processing chamber for processing a wafer is placed inside a pressure-reducible vacuum vessel. A wafer is transferred under reduced pressure in the vacuum transfer unit. The vacuum transfer unit includes a vacuum transfer vessel 110 having a generally polygonal (in this embodiment, generally hexagonal) planar shape as viewed from above. The vacuum transfer vessel 110 includes a vacuum transfer chamber in which a vacuum transfer robot 115 for transferring a wafer is placed. The vacuum transfer unit further includes a plurality of load/unload vessels for connecting the vacuum transfer vessel 110 to the atmosphere side block 151. The wafer transferred between the atmosphere side block 151 and the processing units 101, 102, 103, 104 is passed through the load/unload vessel. The interior of these vessels and units can be maintained at a reduced pressure of a high degree of vacuum. The vacuum side block is a block for vacuum processing.

The processing units 101, 102, 103, 104 of the vacuum side block 152 in this embodiment are removably attached to the vacuum transfer vessel 110 so as to be juxtaposed on the sidewall constituting adjacent sides of its generally hexagonal shape. In this embodiment, each of these processing units 101, 102, 103, 104 is a plasma processing unit where the wafer transferred from the cassette to the vacuum side block 152 is transferred into its processing chamber and processed by a plasma generated in the processing chamber. Each processing unit 101, 102, 103, 104 includes a vacuum vessel in which the processing chamber therein is sealed and maintained at a reduced pressure of a high degree of vacuum to serve as a space for processing a wafer.

More specifically, the vacuum vessel of the processing unit 101, 102, 103, 104 has a sample stage 121, 122, 123, 124 in the processing chamber. A wafer or other sample is mounted on the sample stage. The processing chamber is an inner space of the vacuum vessel, which is decompressed to a predetermined pressure (vacuum pressure). While a processing gas is supplied into the processing chamber, an electric or magnetic field is applied thereto from an electric or magnetic field supply means to generate a plasma in the space above the sample stage of the processing chamber, and the surface of the sample is processed.

Among the processing units 101, 102, 103, 104, the two processing units 102, 103 located behind are etching units for etching a wafer in the processing chamber inside the vacuum vessel. The upper section of the vacuum vessel of the processing units 102, 103 is a discharging section of the processing chamber in which a plasma is generated. Electromagnetic wave sources 118, 119 are placed on the outer periphery side and the upside of the discharging section. The electromagnetic wave source 118, 119 includes an electromagnetic coil for supplying a magnetic field required for plasma generation, and a radio wave source for supplying an electric field for plasma generation placed thereabove. For maintenance and inspection of the electromagnetic wave sources 118, 119, or for maintenance and inspection of the interior of the processing chamber by opening the vacuum vessel to the atmosphere, the electromagnetic wave sources 118, 119 needs moving upward.

To this end, in this embodiment, hoists 116, 117 such as lifters or cranes for vertically moving the electromagnetic wave sources 118, 119 are attached to the side face of the vacuum vessel of the processing units 102, 103. The hoists 116, 117 facilitate opening the vacuum vessel for maintenance and inspection operations by a user.

The processing units 101, 104 serve as ashing units for ashing the mask on the surface of the wafer that has been etched in the processing units 102, 103. Although not shown, a radio wave source for supplying an electric field required for plasma generation is placed also above the vacuum vessel of each of the processing units 101, 104. The processing units 101, 102, 103, 104 may be processing units for film growth or sputtering.

As described later, below the vacuum vessel of each processing unit 101, 102, 103, 104 is placed a vacuum pump, which is an evacuation means for reducing pressure in the processing chamber placed in the vacuum vessel. Furthermore, the vacuum vessel and the vacuum pump coupled thereto are supported on a support or bed 111, 112, 113, 114. A plurality of support pillars for supporting the vacuum vessel by coupling the bed to the vacuum vessel are placed on the bed 111, 112, 113, 114. Each processing unit 101, 102, 103, 104 is fixed and held on the floor where the vacuum processing apparatus 100 is installed.

An evacuator, not shown, is connected to each of the plurality of load/unload vessels constituting the front end of the vacuum side block 152. Each load/unload vessel includes a lock chamber 106, 107. The interior of the lock chamber is a space where the pressure can be maintained in the state of a high degree of vacuum and in the state of atmospheric pressure. The atmosphere side block 151 or housing 109 is communicably connected to the vacuum transfer chamber by the opening-closing motion of gate valves, not shown, placed at the front and back end of the lock chamber. Thus the lock chamber 106, 107 is an opening-closing mechanism for exchanging a wafer between the atmospheric transfer chamber 109 with a cassette coupled thereto and the vacuum side block, and also serves as a variable pressure interface.

In this embodiment, the lock chambers 106, 107 have equivalent functions. Each lock chamber is not limited to only one of the pressure changes from vacuum to atmospheric pressure and from atmospheric pressure to vacuum. However, depending on the required specification, one lock chamber may be limited to one pressure change. In this embodiment, the lock chambers are used for both pressure changes, and hence simply referred to as lock chambers 106, 107.

In the vacuum processing apparatus 100 of this embodiment thus configured, a wafer is exchanged between a cassette mounted on the cassette mounting stage 105 of the atmosphere side block 151 and one of the processing units 101, 102, 103, 104 of the vacuum side block 152. Various sensors attached to the vacuum processing apparatus 100, as well as the atmospheric transfer robot 108, the aligner 200, the lock chambers 106, 107, the vacuum transfer robot 115, the processing units 101, 102, 103, 104 are coupled to a main controller 120, transmit sensed results to and receive commands from the main controller 120, and their operations are adjusted accordingly. Operations such as wafer exchange and processing in the processing units 101, 102, 103, 104 are adjusted by commands from the main controller 120.

The vacuum processing apparatus 100 as in this embodiment is installed on the manufacturing line for manufacturing semiconductor devices by processing semiconductor wafers. In this case, for enhancing the manufacturing efficiency, a plurality of processing systems including the vacuum processing apparatus 100 that perform similar processing are arranged along one line in the same building, and each system exchanges a cassette that contains semiconductor wafers transferred along this line. In the vacuum processing apparatus 100 of this embodiment, the front side of the housing 109 faces the transfer line, and the transferred cassette is exchanged on the cassette stage 105. Because the semiconductor manufacturing line like this requires high cleanliness, the line is constructed entirely in one clean room.

If each system has a large footprint in the building, the number of systems installable in the clean room or other building decreases, and the efficiency of manufacturing semiconductor devices decreases. On the other hand, to avoid this, if the spacing between the systems is reduced, the space for operation around the system by an operator decreases, and the efficiency of maintenance and inspection decreases.

For example, in the vacuum processing apparatus 100 of this embodiment, as the number of wafers processed in the processing units 101, 102, 103, 104 increases, the amount of reaction products or other adherents generated along with the processing and deposited in the processing chamber also increases. The adherents eventually peel off, attach onto the subject wafer, and contaminate the wafer as foreign matter. Hence, typically, after a predetermined number of wafers are processed or the deposition of adherents exceeding a predetermined level is detected in the processing units 101, 102, 103, 104, the vacuum vessel is opened to atmosphere for maintenance such as removal of adherents on the parts and replacement of the parts. In such maintenance, the vacuum vessel is opened to atmospheric pressure, and an operator puts his/her hand in the processing chamber. Thus the space for operation by an operator is needed around the vacuum processing apparatus 100.

However, a decreased space for operation as described above hinders removal and replacement or needs removing extra parts, thereby decreasing the working efficiency. This decreases the operating efficiency of the system and leads to increased cost of manufacturing semiconductor devices. To avoid this and enhance the manufacturing efficiency, it is necessary to decrease the footprint of each processing system installed on the line or to decrease the length of the system in the direction along the transfer line.

In this embodiment, hoists 116, 117 are attached to the side face of the vacuum vessel of the processing units 102, 103, respectively. The side face of the hoist is attached to the side face of the vacuum vessel on the opposite side of the adjacent vacuum vessel. That is, the hoists 116, 117 are attached to the side face opposed to the adjacent processing units 101, 104 serving as ashing units, respectively. Thus the electromagnetic wave sources 118, 119 can be moved upward and then rotated outside the apparatus (outward to the left and right in the figure). Hence a wider space can be allocated for operation on the processing units 102, 103 where an operator can stand between or behind the processing units 102, 103, and the working efficiency is enhanced. Furthermore, an upper member constituting the vacuum vessel of the processing units 102, 103 can be flipped up to the vacuum transfer vessel 110 side about a hinge attached to the vacuum transfer vessel 110 side to open the vacuum vessel. Then the space between the processing units 102, 103 can be used for operation so that an operator can work with the two vacuum vessels in parallel, and thus the working efficiency is enhanced.

Furthermore, in the vacuum processing apparatus 100 of this embodiment, the frontside of the housing 109 is generally parallel to the direction of the transfer line. The vacuum side block 152 is horizontally symmetrical with respect to the plane in the depth direction perpendicular to its frontside, which is the vertical direction in the figure. That is, behind the housing 109, the planar shape of the vacuum transfer vessel 110 is a generally axisymmetrical hexagon as viewed from above. On both sides of the imaginary plane generally perpendicular to the floor of the building (vertically extending plane) overlapping the line of symmetry, the processing units 102, 103 and the processing units 101, 104 attached to the side face of the vacuum transfer vessel 110 are symmetrically arranged including the shape of the vacuum vessel, the internal shape of the processing chamber, the arrangement of the parts, and the shape and orientation of the electromagnetic wave sources 118, 119. This also applies to the load/unload vessels.

In order to reduce the footprint of the vacuum side block 152 including the symmetrically arranged units and vessels or to reduce the width in the transfer line direction in the vacuum processing apparatus 100, the vacuum vessels of the processing units 102, 103 are brought close to each other so that the side faces of the vacuum transfer vessel 110 to which the vacuum vessels are coupled make an obtuse angle. Furthermore, the lines connecting the center of rotation of the vacuum transfer robot 115 rotated in the vacuum transfer chamber in the vacuum transfer vessel 110 with the positions corresponding to the centers of wafers mounted on the upper face of the sample stages 122, 123 in the processing units 102, 103, respectively, make an acute angle θ.

The atmospheric transfer robot 108 of this embodiment retrieves a wafer contained in the cassette mounted on the cassette mounting stage 105, carries it to the atmospheric transfer chamber in the housing 109, and then transfers it into the aligner 200 placed on the left side face of the housing 109. The wafer is subjected to alignment including centering and notch alignment by the aligner 200, and then transferred into the lock chamber 106 or 107 again by the atmospheric transfer robot 108.

The wafer transferred into the lock chamber 106 or 107 is mounted on the sample stage placed therein. After the interior is sealed and decompressed, the gate on the vacuum transfer vessel 110 side is opened with the wafer being lifted up by a plurality of pin-shaped pushers placed in the sample stage, and a hand placed at the tip of an arm of the vacuum transfer robot 115 moves to below the wafer. By downward motion of the pushers, the wafer is passed onto the hand, and the pushers are stored again into the underlying sample stage. Upon completion of wafer exchange, the arm of the vacuum robot 115 is retracted, and the wafer mounted on the hand is carried into the vacuum transfer chamber in the vacuum transfer vessel 110.

In the vacuum transfer chamber, with the wafer mounted on the hand and the arm retracted, the vacuum transfer robot 115 is rotated about the rotation axis at its center and directed to a processing chamber 101, 102, 103, 104. After the vacuum transfer robot 115 is directed to a position suitable for transfer to the intended processing unit, the arm is stretched so that the wafer on the hand at the tip is moved into the intended processing chamber. The wafer transferred into the processing chamber is held therein and subjected to etching or other processing.

For example, in the case where the intended processing unit is the processing unit 102, the arm of the vacuum transfer robot 115 is stretched from the position where the center position of the wafer on the hand in FIG. 1 is located on the line directed from the rotation axis of the vacuum transfer robot 115 to the scheduled center position of the wafer to be mounted on the sample mounting surface on the sample stage 122. Thus the wafer is mounted on the upper face of the sample stage 122. Like the load lock chamber 106, 107, the sample stage 122 is equipped therein with a plurality of pusher pins that move vertically for vertically moving a wafer. With the wafer being moved to above the mounting surface of the sample stage 122, the pusher pins move upward to lift the overlying wafer above the hand. Thus the wafer is transferred from the hand onto the pusher pins. The arm is retracted to move the hand away from above the sample stage 122. Then the pusher pins are moved downward into the sample stage 122. Thus the wafer is passed onto the sample stage 122.

The arm is moved into the vacuum transfer chamber, and the processing chamber is closed. Then the electrode placed in a dielectric adsorption film constituting the mounting surface of the sample stage 122 is energized to electrostatically adsorb and hold the wafer on the mounting surface. Then a processing gas is introduced into the processing chamber, which is evacuated by the vacuum pump for adjustment to a predetermined pressure (vacuum pressure). A heat transfer gas such as He is introduced between the wafer mounting surface and the wafer backside to adjust heat transfer between the wafer and the sample stage. Thus the temperature of the wafer surface is adjusted within a desired range.

In this condition, the processing gas is turned into a plasma by an electric and magnetic field supplied from the electromagnetic wave source 118 to the space above the wafer in the processing chamber. This plasma is used to etch the wafer surface. Upon detection of the completion of a predetermined etching process, the supply of the processing gas is stopped to extinguish the plasma, and the electrostatic adsorption force is reduced. Then the pusher pins are raised to lift up the wafer from the wafer mounting surface. After the gate valve sealing the processing chamber is opened, the arm of the vacuum transfer robot 115 is stretched to move the hand at the tip to below the wafer. By descent of the pusher pins, the wafer is mounted on the hand and passed to the arm. Then the wafer is transferred out and returned to the original position of the original cassette in the atmosphere side block, contrary to before processing.

In the operation of the vacuum processing apparatus 100 as described above, the operation of each part is adjusted by commands from the main controller 120. The main controller 120 may be connected to the controllers controlling the operation of each part of the vacuum processing apparatus 100 so that commands can be exchanged therebetween, or the main controller 120 may be integrated with such controllers. Furthermore, the main controller 120 may be configured so that it can communicate with a controller adjusting the operation of the manufacturing line on which the vacuum processing apparatus 100 is installed, and that the main controller 120 can transmit command signals for adjusting the operation of the vacuum processing apparatus 100 based on the commands from this controller.

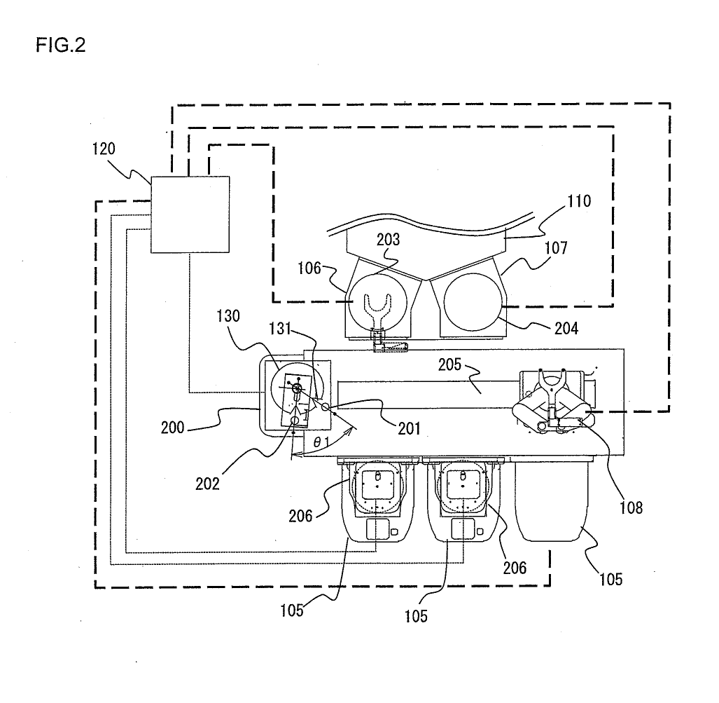

FIG. 2 is a schematic enlarged view of the configuration of an atmosphere side block of the vacuum processing apparatus shown in FIG. 1. As shown, three mounting stages 105 for mounting transferred cassettes 206 are placed on the frontside of the housing 109. Load/unload vessels are attached to the backside of the housing 109 so that the corresponding lock chambers 106, 107 can communicate with the atmospheric transfer chamber. An aligner 200 is attached to the left side face of the housing 109. A wafer 130 is retrieved from the cassette 206 mounted on the cassette stage 105, and the wafer 130 is mounted on the aligner 200. The aligner 200 can rotate the mounted wafer 130 about its axis. The aligner 200 includes a measurement device, which can detect a relative position of a specific feature such as a notch, incision, or hole previously formed at a specific site on the periphery of the wafer 130 with respect to the center of the circular wafer 130. That is, the measurement device can detect the reference site intended for determining the angular position of the specific site about the center. Accordingly, the aligner 200 can detect the reference site of the transferred wafer 130 at least at two arbitrary positions and hold it still so that the reference site with respect to the measurement device are aligned at the two positions.

The aligner 200 of this embodiment uses optical measurement means 201, 202 placed at two sites along the periphery of the wafer 130 to measure the position of the notch 131 formed in the wafer 130 so that the wafer 130 can be aligned at two arbitrary positions. Besides the aligner 200 in the atmosphere side block, the vacuum processing apparatus 100 of this embodiment has no other means for determining or adjusting the reference site of the subject wafer 130. That is, the aligner 200 is the only means for aligning the wafer 130 on the transfer path before processing from the cassette 206 to one of the processing units 101, 102, 103, 104.

The aligned wafer is transferred from the aligner 200 into one of the lock chambers 106, 107 again by the atmospheric transfer robot 108. The transferred wafer is mounted on a sample stage in the lock chamber 106 or 107, and then transferred to an intended one of the processing units 101, 102, 103, 104 by the vacuum transfer robot 115 under reduced pressure. These operations of the vacuum processing apparatus 100 are also adjusted by commands from the main controller 120 as described above.

For example, upon receipt of an output from a sensor (not shown) placed in the cassette 206 on the cassette stage 105 or in the housing 109 connected to the cassette 206, the main controller 120 detects processing information recorded in the cassette 206 including the processing condition, the processing sequence, and the intended processing chamber corresponding to the subject wafer 130. On the basis of the detection result, the main controller 120 adjusts the operation of the atmospheric transfer robot 108, the aligner 200, and the lock chamber 106, 107 to transfer the subject wafer 130 aligned in conformity with the processing in the intended processing unit from the atmosphere side block 151 to the vacuum side block 152.

In the vacuum side block 152, when completion of pressure reduction in the lock chamber 106 or 107 is detected, the main controller 120 transmits a command to the vacuum transfer robot 115 to adjust its operation and transfers the wafer 130 into an intended site. The wafer 130 is transferred to one of the processing chambers (e.g. the processing chamber of the processing unit 103), which is detected by an output from a sensor (not shown) placed in the sample stage 123 at a predetermined reference site (notch 131). Then the main controller 120 transmits command signals to the subject processing chamber to process the wafer 130 in the closed processing chamber. The condition of this processing is also adjusted by commands from the main controller 120.

When completion of processing of the wafer 130 is detected, the wafer 130 is transferred out in the reverse direction along the carry-in path to one of the lock chamber 106, 107. Then commands are transmitted to the atmospheric transfer robot 108 so that the wafer 130 carried to the atmosphere side block 151 is stored in the original position of the cassette. Here, the sample stage 121, 122, 123, 124 in the processing unit 101, 102, 103, 104 has a generally cylindrical shape, and its upper face for mounting a wafer is equipped with a mounting surface made of a generally circular dielectric film. The mounting surface has a site shaped in conformity with a specific feature such as the above-described incision or hole on which the specific feature of the wafer is to be mounted. For example, the mounting surface has an incision generally similar to the incision on the periphery of the wafer so that the incision of the wafer matches the outer periphery of the mounting surface when the wafer is mounted.

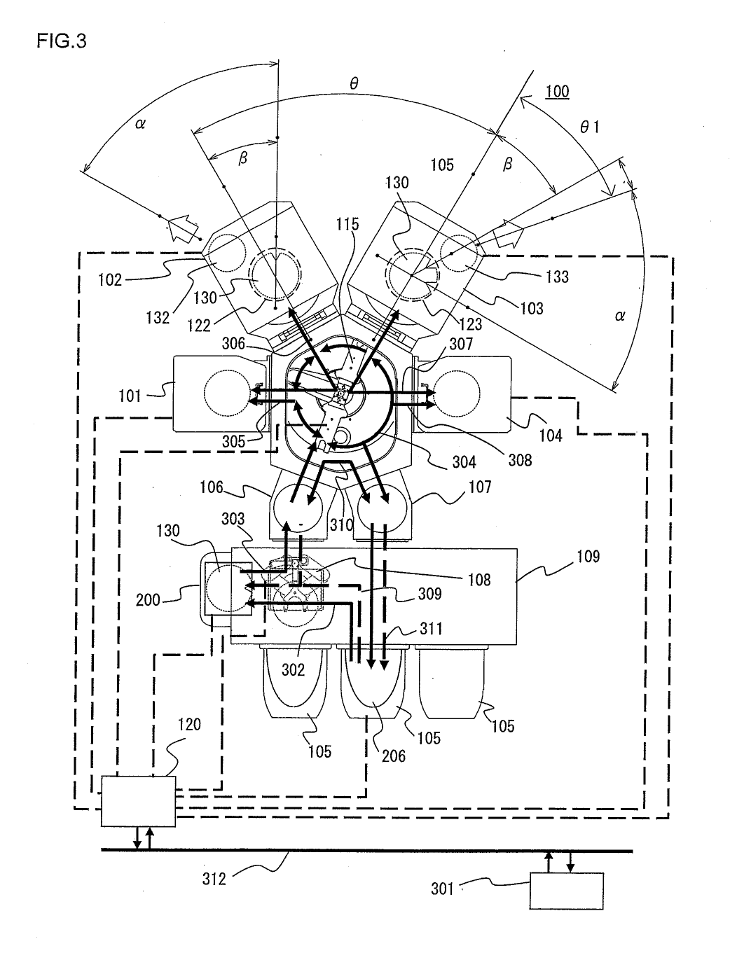

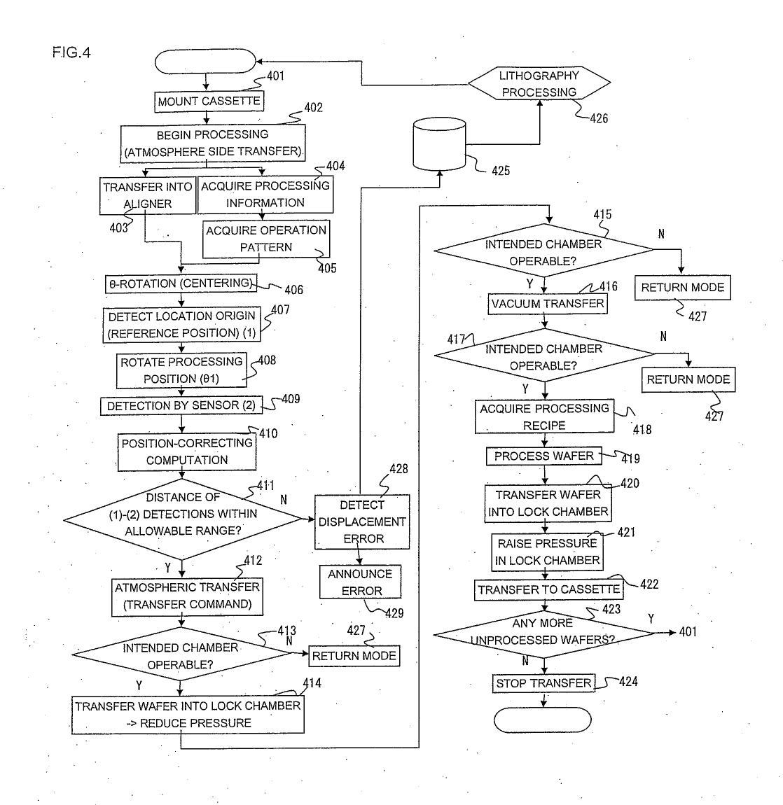

The flow of processing operations in this embodiment is described with reference to FIGS. 3 and 4. FIG. 3 is a plan view showing the processing flow of wafer transfer performed by the vacuum processing apparatus shown in FIG. 1. FIG. 4 is a flow chart showing the flow of operations in the vacuum processing apparatus according to the embodiment shown in FIG. 1.

In these figures, before the vacuum processing apparatus 100 of this embodiment begins wafer processing, at least one cassette 206 containing a plurality of wafers as a set of samples is mounted on the cassette mounting stage 105 in the atmosphere side block 151 (step 401), and the main controller 120 receives a command for processing transmitted from a line controlling computer or other controller in the clean room through a user or communication means (step 402).

Upon receipt of this command, the main controller 120 specifies one of the wafers contained in a particular one of the cassettes 206 corresponding to the content of the command as a subject wafer 130 and transmits a command to the atmospheric transfer robot 108 to transfer the wafer 130 from the containing cassette 206 into the aligner 200. Upon receipt of this command, the atmospheric transfer robot 108 retrieves the wafer 130 from the cassette 206, transfers the wafer 130 to the aligner 200, and mounts the wafer 130 at a predetermined position in the aligner 200 (step 403, arrow 302 in FIG. 3).

Regarding the wafer 130 mounted on the aligner 200, its center position and the position of the specific site on the wafer around the center position are configured and adjusted. In this embodiment, the position of this specific site is configured as follows. Upon specifying a specific subject wafer 130, the main controller 120 acquires information for processing this wafer 130 through a communication means (step 404). Such processing information may illustratively be recorded in the cassette 206 or the body of the wafer 130. The information may be detected by a reader attached to or near the cassette mounting stage 105 of the housing 109, or by a reader placed in the housing 109 or in the aligner 200. Alternatively, the information may be acquired from a database 425 through a communication means, where the database 425 has a memory device capable of communicating with the vacuum processing apparatus 100.

The processing information includes at least information about the processing unit that performs processing and the processing chamber therein. In addition, the processing information may include the film type, thickness, processing shape and other information about the processing object, as well as processing time, pressure, gas, bias electric power and other processing conditions and processing characteristics. The processing characteristics include the distribution of the plasma, gas, and products in the processing chamber of the specified processing unit, the processing rate of the wafer surface, and CD or other shape distribution, resulting from processing a predetermined processing object under a predetermined condition. The information may also include the number of wafers subjected to a predetermined processing.

On the basis of the acquired processing information, the main controller 120 calculates and selects the position of the wafer 130 in the processing chamber of the intended processing unit, and the content and sequence of transfer and processing operations. Here, the information in the communicably provided database, and the apparatus information acquired from the sensors placed in the vacuum processing apparatus 100 about the operating state of the processing units 101, 102, 103, 104 and the number of wafers that can be processed before starting maintenance, are used to select the processing operation and sequence. The processing condition information may include information about the position of the wafer in the aligner 200.

For example, when the subject wafer 130 is to be etched, the acquired information about etching conditions is used to select and configure a suitable processing unit therefor from among the processing units 102, 103. When the subject wafer is to be ashed, the selection is made from among the processing units 101, 104. In this selection, information about the processing performed in one of the processing units can be used to select a processing unit so as to minimize the time from the end of processing of the wafer 130 until the processing of the next wafer can be started, that is, so as to maximize the throughput.

If the processing unit 103, for example, is selected as this processing unit, the main controller 120 acquires information about processing characteristics for the case where the wafer 130 is processed in the processing unit 103 under the acquired processing conditions. The processing characteristics information may be included in the processing conditions. Alternatively, the information stored in the memory device capable of communicating with the vacuum processing apparatus 100 may be received by the main controller 120 through a communication means. Upon acquiring this information, the main controller 120 selects a so-called processing recipe including the sequence and condition for processing the subject wafer 130.

The main controller 120 configures the position of the reference site of the subject wafer 130 by calculating it on the basis of the acquired processing characteristics information or by selecting it from the data contained in the processing information.

Furthermore, the command for (the pattern of) operations by the aligner 200 to align the wafer 130 to the reference site is transmitted to the aligner 200 (step 405). In this embodiment, the acquisition of processing information, the configuration of the position of the reference site, and the transmission of commands to the aligner 200 by the main controller 120 are performed during the period from the reception of commands for the processing in step 402 to the alignment of the wafer 130 on the aligner 200.

In this embodiment, the processing units 102, 103 juxtaposed on adjacent faces of the sidewall of the vacuum transfer vessel 110 having a generally hexagonal planar shape are arranged in a generally symmetric configuration with respect to the vertical plane passing through the center of the vacuum transfer vessel 110 in the front-to-back direction. Thus each of these processing units has different processing characteristics regarding the wafer, which is a substrate sample to be processed.

For example, in this embodiment, each of the processing units 102, 103 includes a vacuum vessel having a generally rectangular solid shape as viewed from outside. A processing chamber having a generally cylindrical shape is located in the vacuum vessel. Furthermore, a sample stage 122, 123 having a generally cylindrical shape is placed concentrically and coaxially with the center of the cylinder of each processing chamber. The sample stage 122, 123 has a generally circular upper face for mounting a wafer.

As described above, a vacuum pump in communication with the processing unit is placed below the vacuum vessel of the processing unit 102, 103. The vacuum pump serves to evacuate the processing chamber. An opening 132, 133 serving as an exhaust port of the processing chamber and as an inlet of the vacuum pump is located below the processing chamber. In this embodiment, the opening 132, 133 is located at an offset position spaced from the central axis of each sample stage 122, 123 (the central axis of the processing chamber) in a generally horizontal direction.

Hence exhaust gas from the processing chamber migrates downward in the internal space of the processing chamber around the sample stage and bends toward the opening 132, 133. It is found that, affected by this migration, the density distribution of the plasma, reaction products, and gas components in the processing chamber above the sample stage 122, 123 is not symmetrical with respect to the above-mentioned central axis, but biased in a specific direction affected by the opening 132, 133. For example, this direction generally matches the direction of the line connecting the central axis of the sample stage 122, 123 with the center of the generally circular opening 132, 133 as viewed from above.

As against such specific direction representing the processing characteristics, the subject wafer also has a predetermined direction. For a semiconductor wafer having a silicon substrate, for example, this direction is the crystal direction of silicon that is determined for facilitating manufacturing the semiconductor device. This direction serves as the reference of processing directionality that is determined for coordinating a plurality of processings prior to etching in the processing unit 102, 103 to improve the accuracy and yield. Conventionally, in order to accurately detect this direction in each apparatus performing a predetermined processing on a wafer, an incision (notch or orientation flat) having a predetermined shape is provided on the outer periphery of the wafer.

As described above, it turns out that the angle between the line connecting this incision with the center of the wafer and the line representing the above-mentioned processing characteristics is desirably consistent among the wafers subjected to the same processing because the former direction greatly affects the processing accuracy and yield. However, as described above, in the configuration of this embodiment, the apparatus configuration of the processing units 102, 103 is arranged symmetrically with respect to the front-to-back axis. Thus the lines representing the processing characteristics are also symmetrically arranged.

Hence, when the processing units 102, 103 can perform the same processing on a wafer surface film having a specification that can be considered as identical, the difference between the processing results in the processing units 102, 103 may be increased if the wafer is placed without considering the direction of processing characteristics relative to the above-mentioned specific direction of the wafer. The increased difference of the shape resulting from the processing, that is, the decrease of processing accuracy, leads to a decreased processing yield and impairs the processing efficiency.

Thus, recently, in order to improve the processing accuracy, uniform processing results are required among a plurality of processing chambers or processing units performing the same processing. To this end, wafer mounting is required to take their processing characteristics into consideration.

Furthermore, the processing characteristics are affected by the difference of the apparatus configuration, which includes the shape of the sample stage and the apparatus for supplying an electric or magnetic field for plasma generation in addition to the above-described evacuation apparatus, and the arrangement of members constituting the inner surface of the processing chamber. Moreover, the processing characteristics are also varied by the difference of conditions for the processing performed in the processing chambers or processing units. For example, when the same processing is performed on wafers having the same specification in different processing chambers, the strength and frequency of the electric field, the gas pressure, the gas flow rate and other processing conditions are typically different for each processing chamber because the specification and structure are slightly different for each processing chamber.

That is, the processing conditions and characteristics are different for each processing unit. Depending on the different processing conditions, the above-mentioned specific direction of the wafer can be adjusted to an arbitrary direction to make the processing result uniform. In light of the foregoing, in this embodiment, the processing information acquired by the main controller 120 in steps 404, 405 includes the identity of a processing chamber where the processing is to be performed and which is the target of transfer, and the angle determined accordingly between the line connecting the wafer incision with its center and the specific direction regarding processing characteristics in the processing chamber. The processing information may include a value of the direction to be aligned by the aligner 200, which is determined accordingly. The processing information may also include the processing conditions and the direction regarding the above-mentioned characteristics.

On the basis of such processing information, the vacuum processing apparatus 100 of this embodiment adjusts the above-mentioned center position and incision position of the subject wafer 130 in the aligner 200 to predetermined values. For example, when the wafer 130 is processed in the processing unit 103 on the basis of the processing information, the angle between the line connecting the incision with the center and the line representing the processing characteristics, e.g., the line connecting the center of the sample stage 123 with the center of the opening 133, is adjusted by the main controller 120 to angle α in the processing unit 102.

As shown in FIG. 3, let β be the angle that the line connecting the incision with the center of the wafer 130 mounted on the sample stage 122 in the processing unit 102 after alignment by the aligner 200 makes with the line connecting the rotation center of the sample stage 122 with the rotation center of the vacuum transfer robot 115. Furthermore, let a be the angle that the line connecting the incision with the center of the wafer 130 makes with the line indicating the direction regarding the processing characteristics. Then, when the wafer 130 is transferred to the processing unit 103 after the same alignment operation by the aligner as in the case of the processing unit 102, the angle between the line connecting the incision with the center of the wafer 130 and the line connecting the rotation center of the sample stage 122 with the rotation center of the vacuum transfer robot 115 is also equal to β, and the angle between the line connecting the incision with the center of the wafer 130 and the line of the direction of processing characteristics in the processing unit 103 is not equal to α as in the processing unit 102.

According to this embodiment, in order to obtain the same result as obtained for the wafer 130 in the processing unit 102, the incision of the wafer 130 transferred to the processing unit 103 is located so that the angle between the line connecting the incision with the center of the wafer 130 and the line connecting the center of the wafer 130 (sample stage 123) with the center of the opening 133 is equal to α. In the vacuum processing apparatus 100 of this embodiment, the angle used by the aligner 200 in aligning the wafer 130 scheduled to be processed in the processing unit 103 is configured by considering the predetermined transfer path via the lock chamber 106 or 107 and the vacuum transfer robot 115 as well as the above-mentioned position of the wafer 130 on the sample stage 133 in the processing chamber of the processing unit 103.

After the wafer 130 is transferred into the aligner 200 in step 403, the reference site provided in the wafer 130, e.g., the position of the incision (notch) 131 formed on the outer periphery of the wafer 130, is detected by the optical measurement device 201 or 202 on the basis of a command received from the main controller 120. Such an incision is provided in order to align the configuration on a wafer surface in each step of processing the wafer for manufacturing semiconductor devices. First, with the wafer 130 being mounted on the mounting stage of the aligner 200, the wafer 130 is rotated about the central axis of the mounting stage, and the position of the notch 131 is detected by the optical measurement device 201 (step 406). When the notch 131 rotated about the center is located directly downward, the position is used as the reference for positioning (the origin of locating) the wafer 130, where the rotation of the wafer 130 is stopped (step 407).

Next, the wafer 130 is rotated about the above-mentioned center from the above-mentioned origin by a predetermined angle θ1 obtained on the basis of the processing information, and then stopped (step 408). The angle θ1 is determined by processing characteristics in the processing chamber of the processing unit 103. For example, the angle θ1 is a parameter indicating the processing characteristics affected by the relative arrangement of the vacuum pump 132, 133 or other exhaust apparatus for evacuating the processing chamber with respect to the center of the sample mounting surface of the sample stage 122, 123 in the processing chamber of the processing unit 102, 103. The parameter can be expressed by the angle that the direction from the center of the mounting surface of the sample stage 122, 123 toward the center of the inlet of the vacuum pump 132, 133 makes with the direction from the center of rotation of the vacuum transfer robot 115 toward the center of the mounting surface of the sample stage 122, 123.

Depending on the condition in the processing chamber where the wafer is to be processed, the position of the predetermined incision of the wafer 130 transferred to the aligner 200 is measured by the optical measurement device 201. In this embodiment, the measurement result is transmitted to the main controller 120 through a communication means, and the incision position of the wafer is detected by a detection apparatus including a computer, not shown, placed in the main controller 120 (step 409). Here, a computation for correcting the notch (incision) position is performed (step 410). It is determined from the outputs from step 407 and step 409 whether the distance between the two notch positions is within the range of allowable values (step 411). If the distance exceeds the allowable limit, the flow proceeds to step 428, where a displacement error is announced. Then the flow transitions to the error mode, where the operation of the vacuum processing apparatus 100 is stopped (step 429).

As described later, the measured data of the predetermined notch position of the unprocessed wafer is stored in a memory device, not shown, in the main controller 120. The data is also stored as information of the database 425 in a memory device communicably connected to the main controller 120. Furthermore, using the information in the database 425 recorded by associating the wafer numbers of unprocessed wafers and processing chamber numbers with processing recipes, the main controller 120 selects or determines a recipe of the condition and sequence for processing the unprocessed wafer in the processing chamber.

When it is determined that the notch position of the wafer 130 aligned by the aligner 200 is within the margin of error, the alignment is completed. Then the wafer 130 is transferred to one of the load lock chambers 106, 107 by the atmospheric transfer robot 108 (step 412). Here, when the measurement in the aligner 200 is completed, one of the load lock chambers 106, 107 is selected as a transfer target while the wafer is placed in the aligner 200. In this embodiment, each of the two lock chambers 106, 107 is configured so that the wafer 130 is subjected to only one operation of loading (carry-in) to and unloading (carry-out) from the vacuum side block 152. For example, the lock chamber 106 is used for loading only. Thus the operating state of the lock chamber 106 is checked. If it is in operation, the wafer 130 is caused to wait in the aligner 200.

If it is determined that the load lock chamber 106 is out of operation or no wafer is placed therein, then the wafer 130 is transferred from the aligner 200 to the lock chamber 106 (step 412, arrow 303 in FIG. 3). Note that this embodiment is configured so that an unprocessed wafer that has completed the predetermined notch alignment can be transferred from the aligner 200 to any of the lock chambers 106, 107.

During the transfer of the wafer 130, the main controller 120 senses the state and operating condition of the processing chamber of the intended processing unit 103 (e.g., the number of times of processing before starting maintenance, the deposited amount of adherents, the temperature of the sample stage, etc.) to determine whether the state satisfies the condition for processing the wafer 130 (step 413). If it is determined that it is operable for processing, the flow proceeds to step 414, where the wafer 130 is transferred into the lock chamber 106 and mounted on the sample stage placed therein. If it is determined that the processing unit 103 does not satisfy the operating condition for processing, the flow proceeds to step 427 and transitions to the return mode, where the wafer 130 is returned to the aligner 200 (step 427).

After the wafer 130 is transferred to the lock chamber 106, the lock chamber is hermetically sealed and decompressed to a predetermined pressure (step 414). As in step 413, during or after pressure reduction, the operating state of the processing chamber in the intended processing unit 103 is sensed to determine whether the condition for processing is satisfied (step 415). If the operating condition is not satisfied, the flow proceeds to step 427, where the vacuum processing apparatus 100 is operated in the return mode for the wafer 130.

When the processing unit 103 is sensed to be operable for processing, after opening the gate valve (not shown) for opening and closing the path through which the lock chamber 106 communicates with the vacuum transfer chamber in the vacuum transfer vessel 110, the wafer 130 is transferred out by the vacuum transfer robot 115 toward the processing chamber in the selected processing unit 103 (step 416). Here again, the vacuum transfer robot 115 of this embodiment can transfer the wafer 130 to and between any of the lock chambers 106, 107 and the processing units 101 etc.

In this embodiment, the vacuum transfer robot 115 for transferring the wafer 130 in the vacuum vessel has a generally vertical rotation axis placed in the vacuum transfer vessel 110. Relative to the processing units placed therearound, the vacuum transfer robot 115 rotates about the above-mentioned rotation axis to transfer a wafer mounted on one of the plurality of (two) arms among the processing units 101, 102, 103, 104 and the lock chambers 106, 107 (arrows 304, 305, 306, 307, 308 in FIG. 3). The vacuum transfer robot 115 of this embodiment can mount and transfer a wafer at the tip of each of the two robot arms that can radially stretch and retract with respect to the above-mentioned rotation axis. For example, with an unprocessed wafer being mounted on one arm, the vacuum transfer robot 115 can wait for completion of processing in an arbitrary processing unit, retrieve another processed wafer from this processing unit, and then transfer the unprocessed wafer into the processing unit in replacement.

While the vacuum transfer robot 115 transfers a wafer 130 mounted on one arm, the main controller 120 senses, as in steps 413, 415, the operating condition of the intended processing unit 103 to determine whether it is operable for processing (step 417). When it is determined that it is operable for processing, the main controller 120 acquires the final processing condition (recipe) for the wafer 130 from the database 425 or a host computer 301 for controlling the manufacturing line shown in FIG. 3 (step 418). The items of this processing condition are equivalent to those in the processing condition acquired in the above-described steps 404, 405 or subsequently.

After the wafer 130 is mounted on the mounting surface of the sample stage 122 in the intended processing unit 103, the vacuum processing apparatus 100 processes the wafer 130 on the basis of the acquired processing recipe (step 419). If the processing unit 103 is not determined to be operable for processing, the main controller 120 operates the vacuum processing apparatus 100 in the return mode of step 427.

If completion of processing is detected, the wafer 130 is transferred from the processing unit 103 to the lock chamber 107 for carrying-out (unloading) by the vacuum transfer robot 115 (step 420). After the wafer 130 is mounted on the sample stage therein, the wafer 130 is returned to the cassette 105 in a reverse manner to the transfer of the wafer 130 into the vacuum side block 152. More specifically, the gate valve is closed, and the unload lock chamber 107 is sealed. Then the pressure is raised to atmospheric pressure (step 421). The gate valve on the atmosphere side block 151 side is opened, and the wafer 130 is transferred out and returned to the original position of the original cassette 105 by the atmospheric transfer robot 108 (step 422, arrow 309 in FIG. 3).

Then the main controller 120 checks whether there are any more unprocessed wafers. If a wafer to be processed is present in the cassette 105, the flow returns to step 402, where the main controller 120 commands the vacuum processing apparatus 100 to perform operations for processing another wafer. If it is determined that there is no wafer to be processed, the flow proceeds to step 424, where further transfer is stopped, and the main controller 120 maintains ongoing operations for processing other wafers or waits for another operation command (step 424).

The measurement result of the notch position of the wafer 130 is transmitted to the main controller 120, where the detection apparatus including a computer detects processing characteristics. The detected processing characteristics are compared with the stored detection result of the notch position before processing. Information in the processing characteristics/recipe correlation database recorded in the database 425 is used to modify the information in the database, such as to modify the content of the recipe selected for each notch position before processing, and thereby the recipe selection may be changed. That is, the information about the processing characteristics of the processed wafer is fed back to the configuration and selection of the recipe of the operating condition and sequence for the subsequent processing of wafers.

In this embodiment, for each wafer targeted to the same processing chamber, its notch position is measured in the aligner 200 before processing, and the notch position data is detected by the main controller 120. Furthermore, the difference of the processing characteristics of each wafer is detected in the subsequent steps in the same processing chamber, and the detection result is reflected in changing or modifying the conditions for the subsequent processing of wafers. Moreover, the information about the modified or new processing recipe resulting from this comparison is transmitted through a communication means so as to be fed back and reflected also in the photolithography or other processing and its condition 426 prior to etching, thereby enhancing the processing accuracy and yield. Furthermore, the measurement information obtained by the aligner 200 about the predetermined notch position of the wafer 130 before processing can also be used to detect the state of the aligner 200 or the optical measurement device installed thereon, thereby determining whether calibration is required.

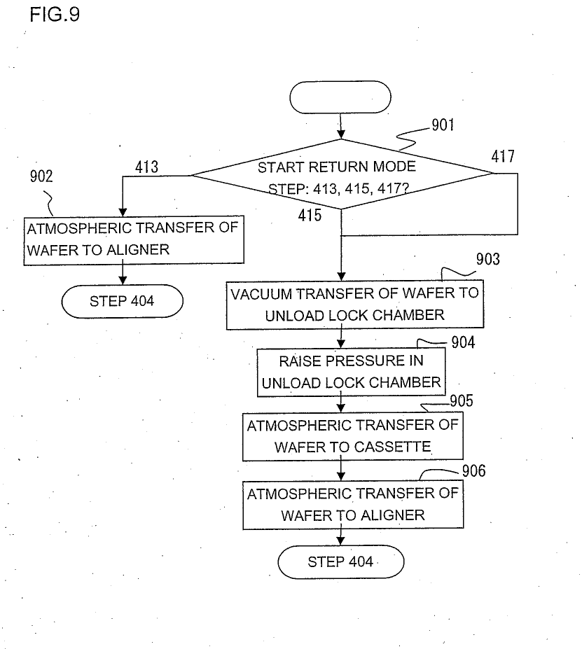

In the following, the operation of the vacuum processing apparatus 100 of this embodiment in the return mode 427 in FIG. 4 is described with reference to FIG. 9, which is a flow chart showing the flow of operations in the return mode shown in FIG. 4.

In FIG. 9, the operation of the vacuum processing apparatus 100 in which the return mode 427 is started is determined (step 901). If the return mode 427 is started in step 413, the wafer 130 is mounted on the arm of the atmospheric transfer robot 108 or on the sample stage of the lock chamber 106 before pressure reduction. Hence the wafer 130 is transferred and returned directly to the aligner 200 by the atmospheric transfer robot 108 (step 902). Subsequently, step 404 in FIG. 4 is performed again, where information about the processing chamber of the processing unit to be newly used for processing, the content of the processing, and the alignment adapted thereto is acquired, and the wafer 130 is aligned again.

If it is determined that the return mode 427 is started in step 415 or step 417, the wafer 130 is transferred from the lock chamber 106 to the unload lock chamber 107 (step 903). Then the pressure in the unload lock chamber 107 is raised (step 904). Then the wafer 130 is retrieved and returned to the original position of the original cassette by the atmospheric transfer robot 108 (step 905). Subsequently, the wafer 130 is transferred again to the aligner 200 (step 906), where information about the processing chamber of the processing unit to be newly used for processing, the content of the processing, and the alignment adapted thereto is acquired, and the wafer 130 is aligned again.

Thus, in the semiconductor processing system 100 of this embodiment, during the transfer from the aligner 200 to the lock chamber 106, if it is determined in step 413 that the processing chamber in the intended processing unit 103 is not operable for processing, processing is performed in the processing unit 102 to continue processing the wafer 130. Hence the wafer 130 aligned in conformity with the processing characteristics of the processing unit 103 needs aligning again in the aligner 200 in conformity with the processing characteristics of the processing unit 102.

Because the atmospheric transfer robot 108 of this embodiment has a single arm, the wafer 130 is directly returned to the aligner 200 for realignment (arrow 313 in FIG. 3). If the atmospheric transfer robot 108 has two arms, the wafer 130 may be returned once to the original position of the original cassette.

After transfer to the lock chamber 106 and the start of pressure reduction, the destination of the transfer may be changed from the processing unit 103 to the processing unit 102. In this case, after the pressure reduction of the lock chamber 106 is completed, the wafer 130 is transferred to the unload lock chamber 107 and then to the atmosphere side block 151 (arrow 310 in FIG. 3), and returned to the original position of the original cassette (arrow 311 in FIG. 3). Subsequently, the wafer 130 is transferred again to the aligner 200 and aligned in conformity with the processing characteristics of the newly intended processing unit 102 (arrow 313 in FIG. 3).

The target of transfer may be changed from the processing unit 103 to the processing unit 102 after transfer to the lock chamber 106 but before the start of pressure reduction. In this case, considering the possibility that another wafer has already been transferred to the aligner 200, the wafer 130 may be returned to the original position of the original cassette without pressure reduction and transferred again to the aligner 200 by the atmospheric transfer robot 108 so that alignment for the processing unit 102 is performed.

The target processing unit may be changed during transfer by the vacuum transfer robot 115. In this case, as in the case after the start of pressure reduction in the lock chamber 106, the wafer 130 is transferred to the unload lock chamber 107, and the pressure is raised. Then the wafer 130 is returned to the original position of the original cassette. Subsequently, likewise, the wafer 130 is transferred to the aligner 200 and aligned again.

As described above, in this embodiment, when the target processing unit is changed, the wafer 130 is returned to the aligner 200 and aligned on the basis of new processing information. Here, the processing efficiency is enhanced by returning the wafer to the original position of the original cassette.

Next, a description is given of how the measurement result for each notch position of a wafer is reflected in the operation of wafer processing.

Regarding the processing units 102, 103 in the vacuum processing apparatus 100 of this embodiment, at least the configuration in the processing chamber and the shape and arrangement of the electromagnetic sources 118, 119 are axisymmetrical with respect to the plane in the depth direction perpendicular to the transfer line. Thus the vacuum processing apparatus 100 is configured so that equivalent processing can be applied to samples to be processed. As described above, the processing units 102, 103 of this embodiment are attached and coupled to adjacent sidewalls of the generally polygonal vacuum transfer vessel 110. A sample is transferred to the processing unit 102, 103 by one vacuum transfer robot 115 placed in the vacuum transfer vessel 110. The vacuum transfer robot 115 is rotated about a vertical axis at its center and stretches an arm into the processing unit 102, 103.

In the vacuum processing apparatus 100, the aligner 200 measures the notch position of the wafer before it is processed in the processing chamber. The measurement result in the aligner 200 is transmitted to the main controller 120. A computer located in the main controller 120 is used to detect a predetermined notch position of the wafer.

Here, to enhance etching accuracy is to bring such CD size as close as possible to a desired value, and the processing condition for achieving this must be accurately realized. To this end, as described above, in the aligner 200, the wafer is rotated about the axis generally perpendicular to its surface. The notch position of the wafer needs to be controllable at a plurality of arbitrary positions by using sensors. Furthermore, in each processing chamber, the wafer must be accurately mounted on the sample stage in the processing chamber at an angle where the relative position of the wafer reference position with respect to a specific direction regarding the processing (gas exhaust direction or input direction of source high-frequency waves) is equal.

Furthermore, in order to control the notch position of a wafer at a plurality of arbitrary positions at higher accuracy, this embodiment is configured so that the number of pulses to a driving motor (not shown) for the aligner 200 can be fine-tuned.

The result of measurement made by the aligner 200 or the notch position data of the wafer detected by the main controller 120 is stored in a memory device placed in the main controller 120 or a memory device communicably connected to the main controller 120 through a communication means. Furthermore, the main controller 120 uses the information about the detected notch position of the unprocessed wafer to search the information in the database 425 (recipe/notch position correlation database) or the recipe database stored in another memory device connected through a communication means. The database 425 relates to the correlation between the notch position of unprocessed wafers and processing recipes. Thus the recipe for processing the wafer can be selected or configured.

Furthermore, the information about the detected notch position of the unprocessed wafer is fed back for photolithography processing 426, which includes mask etching for forming a resin resist mask on the wafer surface. The notch position information is used to modify the selection or determination of the recipe for mask etching, thereby modifying (trimming) the shape of the obtained resist mask.

Furthermore, the information about the notch position detected by the main controller 120 is reflected in the recipe/processing characteristics correlation database, which relates to the correlation between the processing recipe and the wafer processing characteristics obtained as a result of its use. That is, the information about the notch position detected before wafer processing stored in the main controller 120 is compared with the information about the processing characteristics detected after the processing to detect the relationship between the recipe used for processing and the processing characteristics such as the amount of variation of the CD size processed using the recipe. When the difference from the information in the recipe/processing characteristics correlation database exceeds a predetermined range, this relationship is used as a feedback for updating the database so that the new data is substituted for or added to the previously obtained data in the database correlating processing recipes with processing characteristics obtained likewise in the previous processing. Furthermore, the modified recipe is stored in the recipe database in a memory device communicably provided outside the main controller 120, and the database is updated accordingly.

Furthermore, the above detection result is fed back to the selection and modification of recipes of the photolithography process for forming a resist mask of the subject wafer, e.g., the process for depositing and etching a mask. Here again, the information in the database about correlations between photolithography recipes and processing characteristics resulting from the processing is updated as needed, and the mask shape resulting from the photolithography processing is adjusted accordingly. Thus the etching accuracy is enhanced. Furthermore, information about the notch position or processing characteristics of the wafer detected by the aligner 200 may be transmitted to the main controller 120 so that the main controller 120 updates the recipe/notch position database.

The following embodiments illustrate various cases where films of the same type are subjected to substantially the same processing to achieve substantially the same processing result in two processing units, e.g. 102, 103, each having a processing chamber with different structure and processing characteristics.

### Second Embodiment

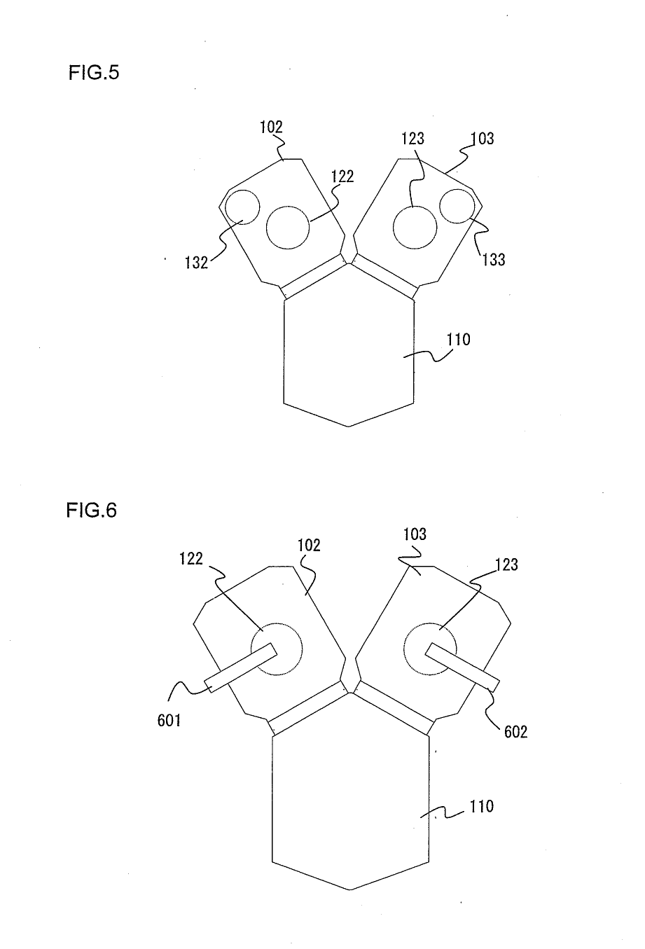

Case 1 of the second embodiment is described with reference to FIGS. 5 and 6. In case 1, there is a structural difference in the vacuum processing apparatus 100. In particular, the processing chambers 101, 102, 103, 104 are different in hardware. For example, FIGS. 5 and 6 illustrate the layout and installation space of the apparatus. The processing units 102, 103 are different in structure due to the symmetrical arrangement. More specifically, the sample stage 122, 123 for mounting a wafer 130 and the waveguide 601, 602 for introducing high-frequency waves for plasma generation are different between the processing unit 102, 103 in the arranging direction, the exhaust direction of process gas and other relative configuration, thereby causing differences in the plasma condition and characteristics in the processing chamber of the processing units 102, 103.

Thus, if product wafers of exactly the same specification are processed in the processing units 102, 103 of different apparatus types with the notch position always made identical by the aligner 200, processing characteristics may not be optimally suited to each apparatus. Thus, the aligner 200 of the invention uses the processing information (database) depending on the processing characteristics of the processing chamber in each processing unit 102, 103. The notch position of each subject wafer 130 transferred from a cassette 206 into the aligner 200 is optimally aligned with high accuracy and flexible control. Then the wafer 130 is transferred along a specified path to a predetermined processing unit so that optimal processing characteristics can be obtained by considering the hardware, plasma condition, process characteristics, and wafer film specification. Thus optimal and accurate wafer processing is achieved.

### Third Embodiment

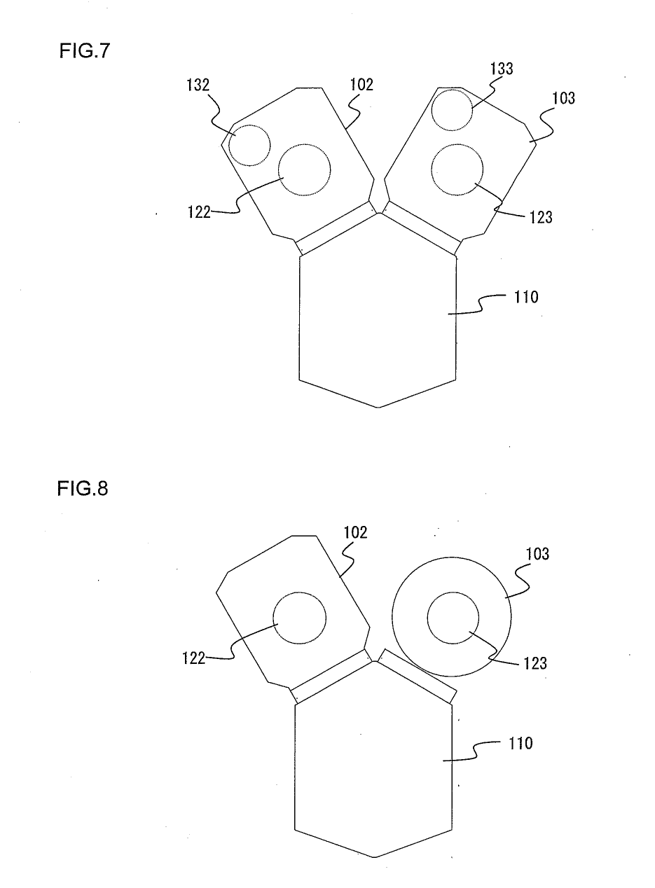

Next, case 2 of the third embodiment is described with reference to FIG. 7. In case 2, there are no structural and processing differences in the vacuum processing apparatus 100. That is, the processing units 102, 103 are asymmetrically arranged, and the process characteristics are identical. For example, in the same apparatus, if the process, the material of the subject film, the wafer film specification, and the processing recipe are the same between the processing units 102, 103, and hence the process gas, processing pressure, and applied voltage are the same between the processing units 102, 103, then the plasma condition and characteristics in the processing chamber of the processing units 102, 103 are the same in theory.

However, in reality, for the following reason, subtle differences often occur in the plasma condition and characteristics. Variations in quality of antennas in the processing chamber, that is, variations of the space due to size differences within the tolerance, may cause differences in the input power of source high-frequency waves due to some difference in antenna installation position. Furthermore, in the sample stage 122, 123 for mounting a wafer 130, the difference in tightening force on the fixing bolts may slightly tilt the sample stage. Thus, in general, the instrumental error in processing characteristics between the processing chambers causes differences in the plasma condition and characteristics in the processing chambers.

Thus, if product wafers of exactly the same specification are processed in the processing units 102, 103 of different apparatus types with the notch position always made identical by the aligner 200, processing characteristics may not be optimally suited to each apparatus. Thus, the aligner 200 of the invention uses the processing information (database) of the apparatus depending on the processing chamber. The notch position of each wafer 130 transferred from a cassette 206 into the aligner 200 is optimally aligned with high accuracy and flexible control. Then the wafer 130 is transferred along a specified path to a predetermined processing chamber so that optimal processing characteristics can be obtained by considering the hardware, plasma condition, process characteristics, and wafer film specification.

Next, case 3 of the third embodiment is described with reference to FIG. 7. In case 3, there are no structural and processing differences in the vacuum processing apparatus 100. That is, the processing units 102, 103 are asymmetrically arranged, and the process characteristics are identical. For example, in the same apparatus, if the process, the material of the subject film, the wafer film specification, and the processing recipe are the same between the processing chambers, and hence the process gas, processing pressure, and applied voltage are the same between the processing chambers in the processing units 102, 103, then the plasma condition and characteristics in the processing chambers are the same in theory.

However, in reality, for the following reason, subtle differences often occur in the plasma condition and characteristics in terms of variation with time in the same processing chamber. As the number of processed wafers 130 increases, variation with time often causes subtle deterioration in processing characteristics (decreased etch rate, increased CD deviation, etc.). The deterioration may be attributed to contamination of the processing chamber by attached reaction products associated with the increase of processed wafers in the processing units 102, 103. Furthermore, the members in the processing chamber such as the gas diffusion plate and the sample stage 122, 123 are worn out by plasma with the increased number of processed wafers. Thus, if product wafers of exactly the same specification are processed in each processing chamber with the notch position always made identical by the aligner 200, processing characteristics may not be optimally suited to each apparatus.

Thus, the aligner 200 of the invention uses the processing information (database) of the apparatus depending on the processing chamber. The notch position of each subject wafer 130 transferred from a cassette 206 into the aligner 200 is optimally aligned with high accuracy and flexible control. Then the wafer 130 is transferred along a specified path to a predetermined processing chamber so that optimal processing characteristics can be obtained by considering the hardware, plasma condition, process characteristics, and wafer film specification. Thus optimal and accurate wafer processing is achieved.

Next, case 4 of the third embodiment is described with reference to FIG. 7. In case 4, there is a difference in the processing of the vacuum processing apparatus 100. In particular, the processing processes in the processing chambers of the processing units 102, 103 are different. For example, in the same apparatus, if the process, the wafer film specification, or the processing recipe is different between the processing units, then the process gas, processing pressure, and applied voltage are naturally different between the processing chambers, and thereby the plasma condition and characteristics therein are different. Thus, if product wafers of exactly the same specification are processed in each processing unit with the notch position always made identical by the aligner 200, processing characteristics may not be optimally suited to each apparatus.

Thus, the aligner 200 of the invention uses the processing information (database) of the apparatus depending on the processing unit. The notch position of each wafer 130 transferred from a cassette 206 into the aligner 200 is optimally aligned with high accuracy and flexible control. Then the wafer 130 is transferred along a specified path to a predetermined processing chamber so that optimal processing characteristics can be obtained by considering the hardware, plasma condition, process characteristics, and wafer film specification. Thus optimal and accurate wafer processing is achieved.

### Fourth Embodiment

Next, case 5 of the fourth embodiment is described with reference to FIG. 8. In case 5, there is a structural difference in the vacuum processing apparatus 100, particularly in the apparatus type. For example, different apparatus types such as ECR, ICP, and UHF naturally lead to differences in the structure, arrangement, and plasma generation scheme of the processing units 101, 102, 103, 104. More specifically, the relative position of the wafer 130 with respect to the input direction of high-frequency waves for plasma generation and the introduction/exhaust direction of the processing gas may be different between the processing units, thereby causing differences in the plasma condition and characteristics in each processing chamber. Thus, if product wafers of exactly the same specification are processed in each processing chamber with the notch position always made identical by the aligner 200, processing characteristics may not be optimally suited to each apparatus.

Thus, the aligner 200 of the invention uses the processing information (database) of the apparatus depending on the processing chamber. The notch position of each wafer 130 transferred from a cassette 206 into the aligner 200 is optimally aligned with high accuracy and flexible control. Then the wafer 130 is transferred along a specified path to a predetermined processing chamber so that optimal processing characteristics can be obtained by considering the hardware, plasma condition, process characteristics, and wafer film specification. Thus optimal and accurate wafer processing is achieved.

Next, case 6 of the third embodiment is described. The vacuum processing apparatus 100 of the above-described cases 1 to 5 uses a notch (or orientation flat) of a wafer 130 illustratively made of a semiconductor silicon substrate (circular). However, it is understood that etching apparatuses using a notch (or orientation flat) of a semiconductor liquid crystal glass substrate (rectangular) can similarly perform wafer processing with higher accuracy in the future. That is, the invention is applicable to substrates with any shape and material. In addition, the optimal variable notch system with high accuracy according to the invention can also be effectively practiced in the following applications. Here, needless to say, the notch (or orientation flat) of a wafer 130 is a very important reference point, as typified by the notch (or orientation flat) of a semiconductor silicon substrate (circular), that controls the directionality of the wafer in photolithography, film formation, and etching.

Next, the operation of the vacuum processing apparatus in calibrating the aligner 200 in this embodiment is described. In this embodiment, the result of detecting a predetermined notch position of a wafer is used to determine the necessity of calibrating the aligner 200. For example, as a result of processing different wafers having the same film structure, if the difference of the obtained shape (e.g. the depth or width of a groove) exceeds a predetermined value, or if the amount of modification to a recipe with respect to its immediately preceding recipe exceeds a predetermined value, then it may be determined that the aligner 200 needs calibrating.

When it is determined that the aligner 200 needs calibrating, calibration is performed by adjusting the number of pulses to the driving motor (not shown) for the aligner 200 or using a jig. On the other hand, when it is determined that no calibration is needed, wafer processing is continued. The vacuum processing apparatus 100 of this embodiment announces that it calibrates the aligner 200 (it is operated in the calibration mode).

Subsequently, the atmospheric transfer robot 108 is used to transfer a calibration wafer from a scheduled position of a predetermined cassette 206 into the aligner 200, and a plurality of notch positions of the unprocessed calibration wafer are detected. It is preferable that the shape of the calibration wafer be previously known by measuring the plurality of notch positions. However, it is also possible to use production wafers with notch position adjusted within a predetermined range.

What is claimed is:

1. A vacuum processing apparatus comprising:
a plurality of vacuum vessels, each having a processing chamber capable of processing a subject substrate sample placed therein under reduced pressure;
a cassette stage for mounting a cassette capable of containing a plurality of the samples;
at least one transfer apparatus for transferring the sample from the cassette to the processing chamber in one of the vacuum vessels along a predetermined path and returning the sample processed in the processing chamber to the cassette; and
an aligner placed on the path between the cassette stage and the plurality of vacuum vessels for aligning the sample to a predetermined position,
wherein the aligner aligns the sample to different positions depending on processings applied to the sample.

2. A vacuum processing apparatus comprising:
a plurality of vacuum vessels, each having a processing chamber capable of processing a subject substrate sample placed therein under reduced pressure;
a cassette stage for mounting a cassette capable of containing a plurality of the samples;
at least one transfer apparatus for transferring the sample from the cassette to the processing chamber in one of the vacuum vessels along a predetermined path and returning the sample processed in the processing chamber to the cassette; and
an aligner placed on the path between the cassette stage and the plurality of vacuum vessels for aligning the sample to a predetermined position,
wherein the aligner aligns the sample to different positions depending on the processing chambers applying processings to the sample.

3. The vacuum processing apparatus according to claim 1, wherein the aligner aligns the sample to different directions depending on characteristics of the processings applied to the sample.

4. The vacuum processing apparatus according to claim 2, wherein the aligner aligns the sample to different directions depending on characteristics of the processings applied to the sample.

5. The vacuum processing apparatus according to claim 1, wherein the sample is shaped like a generally circular plate, and the aligner holds the sample at its center and at a predetermined site having a predetermined shape located on the periphery of the sample around the center so that the transfer apparatus can retrieve the sample from the aligner.

6. The vacuum processing apparatus according to claim 2, wherein the sample is shaped like a generally circular plate, and the aligner holds the sample at its center and at a predetermined site having a predetermined shape located on the periphery of the sample around the center so that the transfer apparatus can retrieve the sample from the aligner.

7. A vacuum processing apparatus comprising:
a transfer vessel having a generally polygonal planar shape in which a subject sample shaped like a generally circular plate is transferred under reduced pressure;
a plurality of processing apparatuses coupled to adjacent sidewalls of the polygon of the transfer vessel, each of the processing apparatuses having a processing chamber capable of processing the sample transferred therein under reduced pressure;
a sample stage placed in the processing chamber in the processing apparatus for mounting the sample on its upper surface;
a cassette stage for mounting a cassette capable of containing a plurality of the samples; and
at least one transfer apparatus for transferring the sample from the cassette to the processing chamber in one of the processing apparatuses along a predetermined path and returning the sample processed in the processing chamber to the cassette,
wherein the plurality of adjacent processing apparatuses are arranged symmetrically with respect to a vertex of the polygon,
the upper surface of the sample stage for mounting the sample has a specific feature which is formed in conformity with a specific shape provided at a predetermined site on the periphery of the sample and on which the predetermined site is mounted, and
the specific feature is equally arranged with respect to a predetermined direction in each of the processing chambers.

8. The vacuum processing apparatus according to claim 7, wherein an incision is provided on the outer periphery of the surface for mounting the generally circular sample, the incision being formed in conformity with the shape of an incision provided on the periphery of the sample.

9. The vacuum processing apparatus according to claim 7, further comprising:
an aligner placed on the path between the cassette stage and the plurality of processing apparatuses for aligning the sample to a predetermined position,
wherein the aligner aligns the predetermined site on the periphery of the sample with the specific feature.

10. The vacuum processing apparatus according to claim 7, wherein in each of the processing chambers, the specific feature is equally arranged with respect to the direction of an exhaust opening located below the processing chamber.

11. The vacuum processing apparatus according to claim 7, wherein in each of the processing chambers, the specific feature is equally arranged with respect to a predetermined direction depending on processing characteristics in the processing chamber.
